(19) United States
(12) Patent Application Publication
(10) Pub. No.: US 2005/0202798 A1
(43) Pub. Date: Sep. 15, 2005

(54) Method and circuit arrangement for switching an electronic circuit into a power-saving mode

(76) Inventor: Alexander Kurz, Schwaebisch Hall (DE)

Correspondence Address: BIRCH STEWART KOLASCH & BIRCH, PO BOX 747, FALLS CHURCH, VA, 22040-0747, US

(21) Appl. No.: 11/071,107

(22) Filed: Mar. 4, 2005

(30) Foreign Application Priority Data
Mar. 6, 2004 (DE) DE 102004010890.0

(51) Int. Cl. H04B 1/06

(52) U.S. Cl. 455/343.1

(57) ABSTRACT

A method and circuit arrangement are provided for switching an electronic circuit into a power-saving mode by a switchover signal that is characterized in that a data output pin of the circuit is simultaneously used as an input pin for an external signal on the basis of which the switchover signal is then produced. When method or circuit arrangement is used, an electronic circuit can be placed in the power-saving mode without the need to provide an additional connecting pin for this purpose.

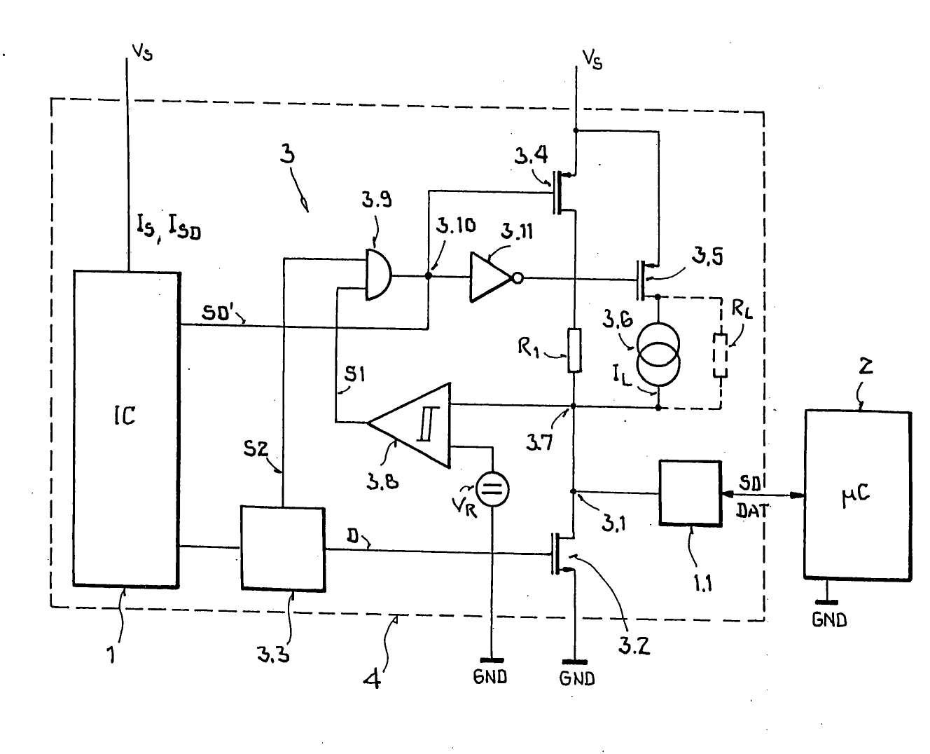

This nonprovisional application claims priority under 35 U.S.C. § 119(a) on German Patent Application No. DE 102004010890.0 filed in Germany on Mar. 6, 2004, which is herein incorporated by reference.

### BACKGROUND OF THE INVENTION

1. Field of the Invention

The present invention relates to a method and a circuit arrangement for switching an electronic circuit into a power-saving mode by a switchover signal.

2. Description of the Background Art

Switchover into a power-saving mode is necessary in particular for circuits powered by a battery voltage, for example in automotive or mobile radio applications, in order to minimize power consumption during the circuit's inactive phases. “Inactive phases” are, for example, those periods of time during which the circuit, which in particular can be an integrated circuit, e.g. an infrared receiver, transmits no data to other electronic assemblies, e.g. a microcontroller.

In prior art methods and circuit arrangements of the aforementioned type, a connecting pin of a circuit is dedicated exclusively to serve as an input pin for the switchover signal, or else an additional pin is provided for the switchover signal. It can be seen as a disadvantage here that either a pin of the circuit is unavailable for other applications, or the provision of an additional pin entails additional manufacturing expense, and is to be avoided in particular in the course of advancing miniaturization of electronic structures, not least on account of the additional space required.

### SUMMARY OF THE INVENTION

It is therefore an object of the present invention to provide a method and circuit arrangement such that the above-mentioned disadvantages are avoided.

The object is attained in a method of the aforementioned type in that a data output pin of the circuit is also used as an input pin for an external signal on the basis of which the switchover signal is then produced. In order to achieve the object in a circuit arrangement of the aforementioned type, provision is made that a data output pin of the circuit can also be used as an input pin for an external signal, with the external signal being the basis for producing the switchover signal. In this way the invention allows the function of a power-saving mode without “tying up” a connecting pin of the circuit or requiring the provision of an additional pin.

In a further development of the method according to an embodiment of the invention, provision is made that a potential value at the data output pin is compared with a reference value, by which a first internal control signal is generated. The first internal control signal is then logically combined with a second internal control signal, and the result of the combination is then used as the switchover signal. Here, the second internal control signal preferably represents an activity of data transmission to the data output pin, so that according to the invention switchover to the power-saving mode can only occur if the second internal control signal indicates a state of absence of data activity. In this way the data output pin effectively functions as a switchover control input only when the circuit to be controlled is not active at the time.

In a circuit arrangement according to the invention, corresponding provision can be made to connect a comparator to the data output pin to compare the external signal to a reference signal and generate a first internal control signal as a function of the comparison result, with the circuit arrangement preferably having an additional signal generating means to indicate an activity of the data transmission to the data output pin by a second internal control signal. In order, as already mentioned above, to permit the use of the data output pin for the purpose of a mode switch only during inactivity of the circuit, the inventive circuit arrangement advantageously has a logical combiner for the first and second internal control signals which is further characterized in that the switchover signal can be generated by the combiner.

To further reduce power consumption in the power-saving mode, in a further embodiment of the present invention, it is provided that, once switchover to the power-saving mode takes place, a pull-up resistor connected between the data output pin and a connection for a supply voltage is replaced by a low current source. Thus, a circuit arrangement can have a switch to replace a pull-up resistor that is arranged between the data output pin and a supply voltage connection with a low current source. In the operating mode of the circuit, the pull-up resistor provides for a defined potential at the data output pin, but would otherwise result in too much current as a result of the applied supply voltage. According to an embodiment of the invention, the switch, which is provided by circuitry to replace the resistor, can also be controlled by the switchover signal.

According to an alternate embodiment of the circuit arrangement, the low current source and the pull-up resistor are connected in parallel and the switch are transistors that are connected directly ahead of the low current source and/or directly ahead of the pull-up resistor. The transistors, like the circuit, can be controlled by the switchover signal.

For the purpose of the simplest possible design of the circuit arrangement according to the invention, the low current source can be embodied as a resistor with a high value in comparison to the pull-up resistor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the single FIGURE shows a circuit arrangement according to an embodiment of the present invention.

### DETAILED DESCRIPTION

The single FIGURE shows a circuit arrangement according to an embodiment of the present invention for switchover of an integrated circuit (IC) 1 at the direction of an external microcontroller (μC) 2. In the example embodiment shown, the integrated circuit 1 is a circuit designed to receive signals in an infrared (IR) portion of the spectrum, i.e. an IR receiver. During normal operation the integrated circuit 1 draws a current I_{S} from a supply voltage V_{S}, for example a battery voltage, and in a power-saving mode (shutdown mode, SD) draws a current I_{SD} that is reduced in comparison to the current I_{S}.

A circuit arrangement 3 in accordance with the invention is wired in operative connection to the integrated circuit 1. In this regard, the circuit arrangement 3 and the integrated circuit 1 can also be integrated together (monolithic), as indicated in the FIGURE by a dashed line 4 (integrated unit).

In accordance with the example embodiment shown, the circuit arrangement 3 includes a data output pin 1.1 of the IC 1, through which the latter transmits received data DAT to the microcontroller 2. Within the circuit arrangement 3, the data output pin 1.1 is connected to a node 3.1 that lies between a supply voltage V_{S}, for example, a battery voltage in which V_{S}=5V, and a ground potential GND. A first switch, which can be a NMOS transistor 3.2, hereinafter referred to as the output transistor, is connected between the node 3.1 and the ground potential GND. The output transistor 3.2 can have a self-cutoff characteristic, and can function as a pull-down transistor with regard to the node 3.1.

The gate electrode of the output transistor 3.2 is connected to a functional unit 3.3 of the circuit arrangement 3, which can be a demodulator, for example, by which the output transistor 3.2 can be controlled at its gate electrode by a signal D. The signal D can be a binary data signal from the IC 1 that is isolated in the functional unit 3.3 from a carrier wave, e.g., a series of HIGH and LOW level values. Whereby, the output transistor 3.2 is cut off in the case when D=0 and conducts when D=1. In the latter case, the node 3.1 is at the ground potential GND.

Connected between the node 3.1 and a connection for the supply voltage V_{S}, starting from the node 3.1 there are a pull-up resistor R₁ and, in series therewith, a second switch, which can be a self-conducting PMOS transistor 3.4. In parallel therewith, the circuit arrangement 3 has a third switch, which can be an additional self-conducting PMOS transistor 3.5, and a current source 3.6 that supplies a low “sense” current I_{L} on, for example, the order of I_{L}=100 nA. Alternatively, the current source 3.6 can also be designed as a resistor R₂ with a value that is high relative to the pull-up resistor R₁ (e.g., R₁=100 kΩ, R₂□R₁), as is shown in the FIGURE with the aid of the dotted connections. Also starting from the supply voltage V_{S}, there are arranged first the transistor 3.5 and then the current source 3.6/the resistor R₂, where the connections of the pull-up resistor R₁ and the current source 3.6/the resistor R₂, which face the node 3.1, terminate in a common node 3.7.

Additionally, the circuit arrangement 3 has a comparison means in the form of a comparator 3.8 whose inputs for comparison are connected to the node 3.7 and to a reference voltage V_{R}, with V_{R}>GND. An output signal S1 of the comparator 3.8, which functions as a first internal control signal, is connected to one of the inputs of a logical combiner, which can be an AND gate 3.9. The second input of the AND gate 3.9 is connected to the functional unit 3.3 for receiving a second internal control signal S2, by which the functional unit 3.3 indicates an activity of data transmission (hereinafter referred to as data activity) from IC 1 to data output pin 1.1. In the embodiment of the invention shown, for example, S2=1 in the absence of data activity (no data burst to the output pin 1.1).

The output of the AND gate 3.9 is connected to an additional node 3.10, which branches off to a gate electrode of the PMOS transistor 3.4, to a gate electrode of the PMOS 3.5 via an inverter 3.11, and to the IC 1 (signal SD′). In this way, both of the PMOS transistors 3.4, 3.5 (complementary to one another) and also the IC 1 can be controlled by the output of the AND gate 3.9.

In normal operation, the transistor 3.4 conducts. As already mentioned, the output transistor 3.2 is controlled by the functional unit 3.3. Thus, via the pull-up resistor R₁ an output signal DAT can be accessed at output pin 1.1 as a direct reproduction of the signal D for further processing by the microcontroller 2. The current Is typically flows at approximately 500 μA.

The circuit arrangement 3 now operates to switch IC 1 into the power-saving mode as follows: the data output pin 1.1 is externally brought to ground potential GND by the microcontroller 2. This process is symbolized in the FIGURE by the arrow SD from the microcontroller 2 to the output pin 1.1. As a result the nodes 3.1, 3.7 drop the voltage at one input of the comparator 3.8 below the reference value V_{R} so that the comparator 3.8 generates the signal S1, here S1=1. This signal is combined with the signal S2 by the AND gate 3.9, with the AND gate then providing a HIGH level output signal to node 3.10 when S1=1 and S2=1 at the same time, which is to say when no data activity is taking place and the external SD signal has been given.

The output signal of the AND gate 3.9 serves firstly as an (internal) shutdown signal SD′ for IC 1. Consequently, the IC 1 can only be switched over into the power-saving mode on the basis of the external signal SD when no data is being transmitted at this moment.

Thus, the data output pin 1.1 of the integrated circuit 1 is used simultaneously as an input pin for the external shutdown signal SD, according to which—as already described in detail above—the internal switchover signal SD′ is subsequently generated.

Secondly, an additional power reduction is achieved on account of the controlling connections from the node 3.10 to the transistors 3.4, 3.5 in the power-saving mode according to the invention. In the event of a HIGH level signal at node 3.10, the PMOS transistor 3.4 cuts off, while the PMOS transistor 3.5 conducts on account of the inverter 3.11. In this way, the pull-up resistor R₁ is replaced by the current source 3.6 or the resistor R₂. This makes it possible to avoid having an excessively high current I=V_{S}/R₁=50 μA flow from the supply voltage V_{S} through the pull-up resistor R₁ in the power-saving mode of the IC 1. In contrast, the quiescent current consumption of IC 1 is only approximately I_{SD}=100 nA. According to the invention, on account of I_{L}=100 nA, a total quiescent current in power-saving mode of I_{SD}+I_{L}=200 nA results, which is to say one 250^{th} of the quiescent current through the resistor R₁. Alternatively, the same result is achieved using a resistor with a high value R₂=50 MΩ in comparison to the pull-up resistor R₁.

It is necessary to switch on the current I_{L} or VS/R2 in order to set the output pin 1.1 at a defined potential even in power-saving mode, i.e. in the absence of data activity; without this current, the output pin would float.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for switching an electronic circuit into a power-saving mode by a switchover signal, wherein a data output pin of the circuit is also used as an input pin for an external signal on the basis of which the switchover signal is then produced.

2. The method according to claim 1,
wherein a potential value at the data output pin is compared with a reference value to thereby generate a first internal control signal;
wherein the first internal control signal is logically combined with a second internal control signal; and
wherein the result of the combination is then the switchover signal.

3. The method according to claim 2, wherein the second internal control signal represents an activity of data transmission to the data output pin.

4. The method according to claim 3, wherein a switchover to the power-saving mode only occurs if the second internal control signal indicates a state of absence of data transmission activity.

5. The method according to claim 4, wherein, once switchover to the power-saving mode takes place, a pull-up resistor connected between the data output pin and a connection for a supply voltage is replaced by a low current source.

6. The method according to claim 5, wherein the replacement by the low current source is controlled by the switchover signal.

7. A circuit arrangement for switching an electronic circuit into a power-saving mode by a switchover signal, wherein a data output pin of the circuit is also used as an input pin for an external signal on the basis of which the switchover signal is then produced.

8. The circuit arrangement according to claim 7, wherein connected to the data output pin is a comparator for comparing the external signal to a reference signal and for generating a first internal control signal as a function of the comparison result.

9. The circuit arrangement according to claim 8, wherein a signal generator indicates an activity of data transmission on the data output pin by a second internal control signal.

10. The circuit arrangement according to claim 9, wherein a logical combiner combines the first and second internal control signals.

11. The circuit arrangement according to claim 10, wherein the switchover signal is generated by the logical combiner.

12. The circuit arrangement according to claim 7, wherein a switch replaces a pull-up resistor, which is arranged between the data output pin and a supply voltage, with a low current source.

13. The circuit arrangement according to claim 12, wherein the low current source and the pull-up resistor are connected in parallel, and wherein the switch is a transistor that is connected directly ahead of the low current source and/or directly ahead of the pull-up resistor.

14. The circuit arrangement according to claim 12, wherein the switch is controlled by the switchover signal.

15. The circuit arrangement according to claim 12, wherein the low current source is a resistor having a higher value than the pull-up resistor.

16. A method for switching an electronic circuit into a power-saving mode, the method comprising the steps of:
detecting an absence of data transmission on a data output pin of the electronic circuit by a detector, the detector providing a first signal to a combiner based on the detection of the absence of data transmission;
detecting a power-save signal on the data output pin by a comparator, the comparator providing a second signal to the combiner based on the detection of the power-save signal, the power-save signal being inputted from an external controller to the data output pin of the electronic circuit;
comparing the first signal and the second signal; and
switching the electronic circuit into the power-saving mode on the basis of the comparison of the first signal and the second signal.

17. The method according to claim 16, wherein an integrated circuit provides data for output on the data output pin, the integrated circuit being integrated in the electronic circuit.

18. The method according to claim 17, wherein the integrated circuit is an infrared receiver.

19. The method according to claim 16, wherein the electronic circuit is switched into the power-saving mode when an absence of data transmission is detected and when a power-save signal is detected.

20. The method according to claim 16, wherein the combiner is an AND gate, the AND gate providing a power-switching mode signal to switch the electronic circuit into the power-saving mode when an absence of data transmission is detected and when a power-save signal is detected.
